(19) United States
(12) Patent Application Publication
(10) Pub. No.: US 2017/0141696 A1
(43) Pub. Date: May 18, 2017

(54) T-CONNECTED AUTOTRANSFORMER BASED CONVERTER PROVIDING REDUCED RATING FOR RETROFIT APPLICATIONS

(71) Applicant: Rohollah Abdollahi, Qom (IR)

(72) Inventor: Rohollah Abdollahi, Qom (IR)

(21) Appl. No.: 15/420,234

(22) Filed: Jan. 31, 2017

(30) Foreign Application Priority Data
Jun. 30, 2016 (IR) 13955014000300419

(51) Int. Cl. H02M 7/06; H02M 1/14; H01F 30/02; H02M 1/12

(52) U.S. Cl. CPC H02M 7/06; H02M 1/12; H02M 1/14; H01F 30/02

(57) ABSTRACT

A 72-pulse clean power AC-DC converter, based on a T autotransformer configuration with reduced kilovolt ampere rating and a THD of lower than 3% is presented. The T-Connected autotransformer based 36-pulse converter is obtained via two paralleled 18-pulse AC-DC converters each of them consisting of a 9-phase (9-leg) diode bridge rectifier. To achieve a 72 pulse output, a pulse doubling circuit is applied which, in one embodiment, is a tapped inter-phase transformer. A T-connected autotransformer is utilized to supply the rectifiers.

### CROSS REFERENCE TO RELATED APPLICATION

This application claims the benefit of priority to an Iran patent application having serial number 139550140003004191 filed on Jun. 30, 2016 and issued as Iran Patent Number 89613 on Aug. 21, 2016, which is incorporated by reference herein in its entirety.

### TECHNICAL FIELD

The present invention relates to a T-connected autotransformer based AC-DC converter, and in particular to a T-connected autotransformer based AC-DC converter providing a specific THD range and configured for harmonic reduction and reduced kilovolt-ampere (kVA) rating.

### BACKGROUND

Recent advances in solid state conversion technology have led to the proliferation of variable frequency induction motor drives (VFIMD's) that are used in various applications such as air conditioning, blowers, fans, pumps for waste water treatment plants, textile mills, rolling mills and the like. As a practical technique, direct torque control (DTC) strategy is implemented in induction motor drives (DTCIMDs) serving various applications. In general, these drives utilize voltage source inverters which are fed from conventional six-pulse diode bridge rectifiers. These rectifiers, though useful, include several disadvantages. One of the most common drawbacks of these rectifiers is their poor power quality injection of harmonic currents into AC mains. The circulation of current harmonics into source impedance results in harmonically polluted voltages at the point of common coupling (PCC), consequently generating undesired supply voltage conditions for nearby costumers. For DTCIMDs, one effective solution to eliminate harmonics is the use of multi-pulse AC-DC converters.

Such converters can be based on phase multiplication, phase shifting, pulse doubling or a combination of these solutions. These options are known in the art and a few are discussed in detail in U.S. Pat. No. 7,274,280. Application of a multi-pulse technique (up to 18-pulse) in AC-DC converters is discussed in U.S. Pat. No. 7,375,996. However, this topology results in line current total harmonic distortion (THD) of more than 5% under different load conditions. Another example, is the use of a polygon-connected autotransformer based 30-pulse discussed in U.S. Pat. No. 7,719,858 which was designed for AC-DC power converter. However, the DC link voltage in this topology is higher than that of a 6-pulse diode bridge rectifier, thus making the scheme non-applicable for retrofit applications. An alternative configuration is the use of a T-connected autotransformer based 40-pulse converter, disclosed in U.S. Pat. No. 8,982,595, for direct torque controlled induction motor drives (DTCIMDs). Such a transformer provides a current THD between 2.55% to 3.79% from full-load to light-load (20% of full-load), respectively.

In some applications, it is necessary to take strict power quality measures. Therefore, it would be beneficial to apply converters with higher number of pulses. For instance, in some cases, harmonics are distinguished as signatures by sonar, and unintentionally are capacitively coupled to ship hull resulting in induced hull currents that make systems such as degaussing equipment malfunction. In such situations, the operation of harmonic generating loads should be limited in order to have a THD equal or less than 3%. The Military Standard 1399 (MIL STD) 1399 sets power supply voltage harmonics at 5% with current harmonics being 3% of the fundamental for loads of 1 KVA or more.

Therefore, a need exists for a solution for providing converters with higher number of pulses that provide a low THD range.

### SUMMARY

The instant application describes a T-connected autotransformer based 72-pulse AC-DC converter, where the T-connected autotransformer based 72-pulse AC-DC converter includes a T-connected autotransformer based 36-pulse AC-DC configuration comprising a T-connected autotransformer and first and second 18-pulse AC-DC converters. In one embodiment, the first and the second 18-pulse AC-DC converters are parallel, and each one of the first and second 18-pulse AC-DC converters comprises a nine-phase diode bridge rectifier.

### BRIEF DESCRIPTION OF THE DRAWINGS

Features of the subject technology are set forth in the appended claims. However, for purpose of explanation, several implementations of the subject technology are set forth in the following figures.

FIG. 1 illustrates a phasor representation of a T-connected autotransformer based 72-pulse AC-DC converter, according to an implementation.

FIG. 2 illustrates a winding arrangement for a T-connected autotransformer based 72-pulse AC-DC converter, according to an implementation.

FIG. 3 illustrates a schematic drawing of a T autotransformer for 72-pulse AC-DC conversion, according to an implementation.

FIG. 4 illustrates a schematic drawing of a Tapped Inter-phase Transformer (IPT) circuit for pulse-doubling in 36-pulse converters, according to an implementation.

FIG. 5 illustrates a MATLAB block diagram of a harmonic mitigator, according to an implementation.

FIG. 6 illustrates a representation of 18-phase autotransformer output voltage waveforms, according to an implementation.

FIG. 7 illustrates a representation of voltage waveforms across a tapped IPT, according to an implementation.

FIG. 8 illustrates a representation of current waveforms of Diodes, according to an implementation.

FIG. 9 illustrates a 72-pulse ac-dc converter output voltage, according to an implementation.

FIG. 10 illustrates an input current waveform and its harmonic spectrum of a six-pulse AC-DC converter, according to an implementation.

FIG. 11 illustrates an input current waveform and its harmonic spectrum of 36-pulse AC-DC converter, according to an implementation.

FIG. 12 illustrates an input current waveform and its harmonic spectrum of 72-pulse AC-DC converter, according to an implementation.

FIG. 13 illustrates variations of THD with load on DTCIMD in 6-pulse, 36-pulse and 72-pulse AC-DC converters, according to an implementation.

FIG. 14 illustrates variations of power factor with load on DTCIMD in 6-pulse, 36-pulse and 72-pulse AC-DC converters, according to an implementation.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings. As part of the description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

This disclosure pertains to a T-connected autotransformer based 72-pulse AC-DC converter with reduced rating for retrofit applications and a THD Lower than 3%. In one embodiment, to achieve a 72pulse output, a pulse doubling circuit is applied which is in one case is a tapped inter-phase transformer. The 36-pulse topology is obtained via two paralleled 18-pulse ac-dc converters each of them consisting of a 9-phase (9-leg) diode bridge rectifier. An autotransformer can be used to supply the rectifiers. Such a system is suitable for retrofit applications where a six-pulse diode bridge rectifier is utilized. In one embodiment, for independent operation of paralleled diode-bridge rectifiers, a zero sequence blocking transformer (ZSBT) is designed and implemented. A tapped inter-phase transformer (IPT) can then be used at the output of ZSBT to double the number of output voltage pulses from 36 to 72. Embodiments of the disclosure have shown significant improvement of power quality indices (consistent with the IEEE-519 standard requirements) at the point of common coupling. Moreover, embodiments have shown to result in input current total harmonic distortion (THD) of less than 3% at variable loads. Furthermore, near unity power factor was obtained for a wide range of DTCIMD operations. Moreover, the preferred embodiment of the present invention achieves considerable reduction in burdens of the magnetic parts with respect to nominal load rating which is verified by kVA calculations. As such, use of the preferred embodiment results in significant improvement in cost and space savings.

It is generally known that for harmonic elimination, the required phase shift is given by the following equation:

$$Phase Shift = \frac{360 °}{Number of Converters \times Number of Pulse} \qquad ( 1 )$$

Accordingly, to achieve a 12-pulse rectified voltage using two 6-pulse three phase legs, connected in parallel, one of the input voltages should have a 30 degrees phase shift with respect to the other. The same idea could be applied to implement AC-DC converters with higher order of pulse numbers. Thus, two sets of 18-pulse bridge rectifiers can be connected in parallel to obtain a 36-pulse AC-DC converter. In other words, parallel connection of two 10 degrees phase shifted sets of 5-phase system of voltages, which are 40 degrees phase shifted with respect to each other, would give us a 36-pulse AC-DC converter.

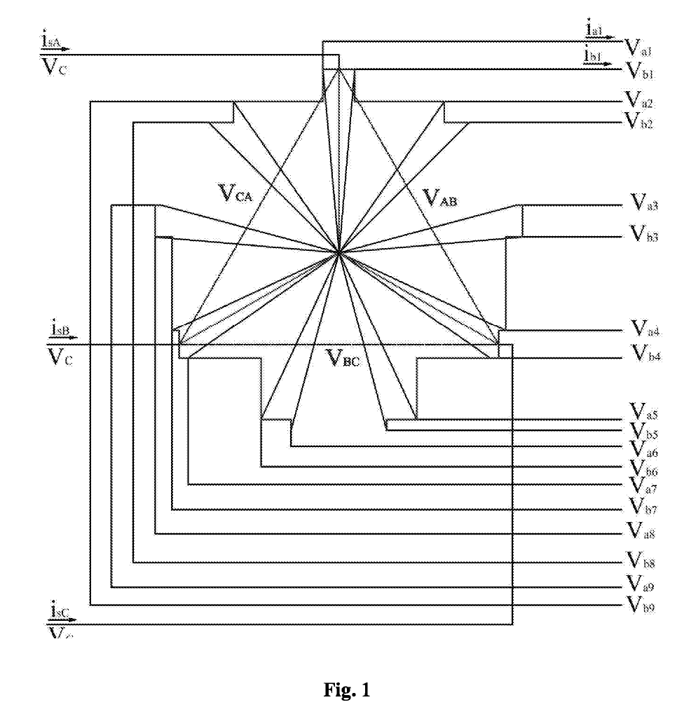

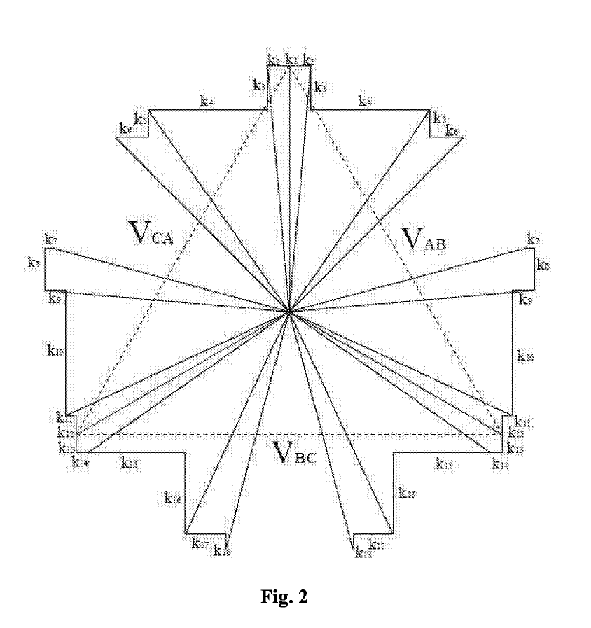

FIG. 1 illustrates the phasor diagram for a T autotransformer with 36-pulse AC-DC conversion is shown in FIG. 1 and FIG. 2, respectively. The two sets of voltages (Vₐ₁, Vₐ₂, Vₐ₃, Vₐ₄, Vₐ₅, Vₐ₆, Vₐ₇, Vₐ₈, Vₐ₉) and (V_{b1}, V_{b2}, V_{b3}, V_{b4}, V_{b5}, V_{b6}, V_{b7}, V_{b8}, V_{b9}) are fed to rectifiers I and II (not shown), respectively. The same voltages of the two groups, i.e. Vₐᵢ and V_{bi}, are phase displaced by 10 degrees.

Vₐ₁ and V_{b1} have phase shifts of +5 and −5 degrees from the input voltage of phase A, respectively. As can be seen in FIG. 1, the nine-phase voltages are made from the AC main phase and line voltages with fractions of the primary winding turns. Consider three-phase voltages of primary windings as follows:

V_{A}=Vₛ∠0°, V_{B}=Vₛ∠120°, V_{C}=Vₛ∠120° (2)

Where, nine-phase voltages are:

Vₐ₁=Vₛ∠+5°, Vₐ₂=Vₛ∠−35°, Vₐ₃=Vₛ∠−75°,

Vₐ₄=Vₛ∠+115°, Vₐ₅=Vₛ∠−155°, Vₐ₆=Vₛ∠−195°,

Vₐ₇=Vₛ∠+235°, Vₐ₈=Vₛ∠−275°, Vₐ₉=Vₛ∠−315°, (3)

V_{b1}=Vₛ∠+5°, V_{b2}=Vₛ∠−45°, V_{b3}=Vₛ∠−85°,

V_{b4}=Vₛ∠+125°, V_{b5}=Vₛ∠−165°, V_{b6}=Vₛ∠−205°,

V_{b7}=Vₛ∠+245°, V_{b8}=Vₛ∠−285°, V_{b9}=Vₛ∠−325°, (4)

Input voltages for converter I are:

Vₐ₁=V_{A}−K₁V_{A}−K₂V_{BC}

Vₐ₂=V_{b1}−K₃V_{A}+K₄V_{BC}

Vₐ₃=V_{b3}+K₈V_{A}−K₇V_{BC}

Vₐ₄=V_{B}+K₁₂V_{A}+K₁₁V_{BC}

Vₐ₅=V_{b4}−K₁₆V_{A}−K₁₅V_{BC}

Vₐ₆=V_{b6}−K₁₈V_{A}+K₁₇V_{BC}

Vₐ₇=V_{C}−K₁₃V_{A}+K₁₄V_{BC}

Vₐ₈=V_{b7}+K₁₀V_{A}−K₉V_{BC}

Vₐ₉=V_{b9}−K₅V_{A}−K₆V_{BC}

Vₐ₃=V_{b3}−K₈V_{A}−K₇V_{BC} (5)

Input voltages for converter II are:

V_{b1}=V_{A}−K₁V_{A}+K₂V_{BC}

V_{b2}=Vₐ₂−K₄V_{A}+K₆V_{BC}

V_{b3}=Vₐ₄+K₁₀V_{A}+K₉V_{BC}

V_{b4}=V_{B}+K₁₃V_{A}−K₁₄V_{BC}

V_{b5}=Vₐ₅−K₁₈V_{A}−K₁₇V_{BC}

V_{b6}=Vₐ₇−K₁₆V_{A}+K₁₅V_{BC}

V_{b7}=V_{C}+K₁₂V_{A}−K₁₁V_{BC}

V_{b8}=Vₐ₈+K₈V_{A}+K₇V_{BC}

V_{b9}=Vₐ₁−K₃V_{A}−K₄V_{BC} (6)

V_{AB}=\sqrt{3}V_{A}∠30°, V_{BC}=\sqrt{3}V_{B}∠30°, V_{CA}=\sqrt{3}V_{C}∠30°, (7)

Constants K₁-K₁₈ are calculated, in one embodiment, using equations (3)-(7) to obtain the winding turn numbers to have the desired phase shift for the two voltage sets as follows:

K₁=0.0038, K₂=0.0503, K₃=0.17704, K₄=0.28026,

K₅=0.11205, K₆=0.0771,K₇=0.01747, K₈=0.17167,

K₉=0.05189, K₁₀=0.50976, K₁₁=0.02326, K₁₂=0.07739,

K₁₃=0.07357, K₁₄=0.027,K₁₅=0.22894, K₁₆=0.33273,

K₁₇=0.09457, K₁₈=0.05962. (8)

In general, the value of output voltage in multi-pulse rectifiers boosts relative to the output voltage of a six-pulse converter, thus making a multi-pulse rectifier not suitable for retrofit applications. For instance, with the autotransformer arrangement of the preferred embodiment of the disclosed 36-pulse converter, the rectified output voltage is approximately 20% higher than that of a six-pulse rectifier. For retrofit applications, the above procedure is modified, in one embodiment, so that the DC-link voltage becomes equal to that of a six-pulse rectifier. In a similar manner, the following equations can be derived as:

|Vₛ|=0.8328|V_{A}| (9)

Accordingly, the values of constants K₁-K₁₈ can be changed for retrofit applications as:

K₁=0.17037, K₂=0.0419, K₃=0.14745, K₄=0.23388,

K₅=0.09331, K₆=0.0642, K₇=0.01455, K₈=0.14296,

K₉=0.04322, K₁₀=0.42453, K₁₁=0.06422, K₁₂=0.14805,

K₁₃=0.02233, K₁₄=0.10613, K₁₅=0.19066, K₁₆=0.2771,

K₁₇=0.07875, K₁₈=0.04965. (10)

In one embodiment, the values of K₁-K18 determine the number of turns for the autotransformer windings to achieve desired output voltages and phase shifts.

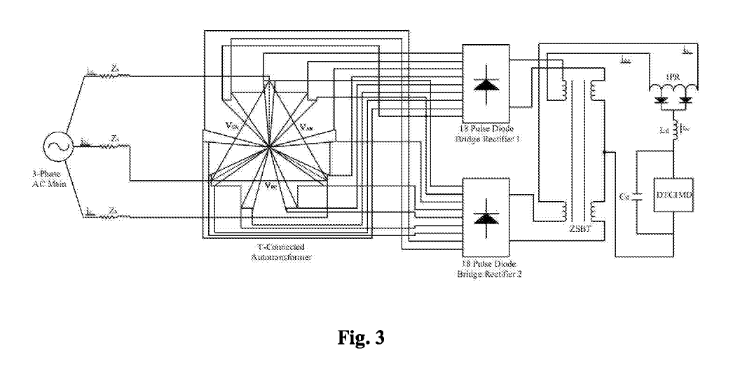

FIG. 3 illustrates one embodiment of a T-connected autotransformer configuration for 72-pulse AC-DC conversion. As shown, current is supplied by an AC main. In one embodiment, the AC main is a 3-phase AC main which supplies current in three separate phases. The supplied current is received by a T-Connected autotransformer which in supplies two parallel 18 pulse diode bridge rectifiers 1 and 2. The rectifiers are connected to a zero sequence blocking transformer (ZSBT). A tapped inter-phase transformer (IPT), which is a pulse doubling circuit, is used at the output of the ZSBT to double the number of output voltage pulses from 36 to 72.

### Interphase Transformer

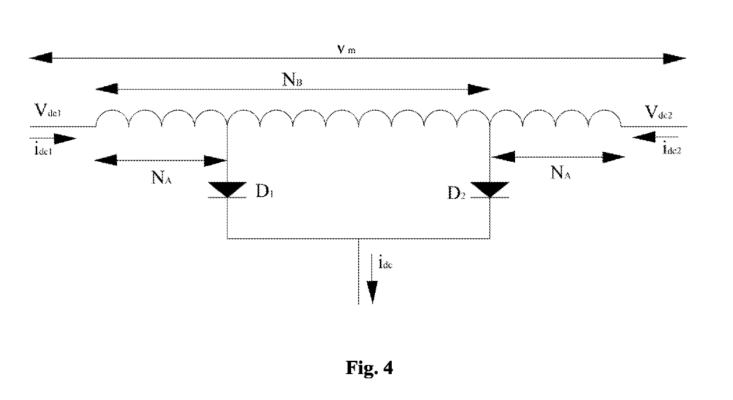

FIG. 4 illustrates one embodiment of an IPT circuit for doubling the number of pulses. To achieve the desired results, in one embodiment, the DC content of the bridge output voltages should be equal and the bridge outputs must be 10 degrees phase shifted. The voltage across the inter-phase transformer has a frequency 18 times greater than the supply voltage. This is an advantage that should be considered over schemes that use lower pulse numbers, because it reduces the weight and size of the inter-phase transformer. It should be noted that Vₘ contains both the negative and positive half cycles. This fact is taken into account for describing the conduction modes for the complementary diodes D₁ and D₂. Positive Vₘ forces D₁ to conduct and vice versa. The following equation describes the mmf balance of the windings in conduction mode of D₁.

i_{dc1}N_{A}=i_{dc2}N_{B} (11)

N_{A} and N_{B} refer to the winding turns illustrated in FIG. 4.

DC currents of the bridges are combined through the inter-phase transformer, resulting in a total DC current, expressed by the following equation:

_{dc1}+i_{dc2}=i_{dc} (12)

Considering (11) and (12), DC current of the bridges can be written as follows:

i_{dc1}=(0.5+Kₜ)i_{dc}

i_{dc2}=(0.5−Kₜ)i_{dc} (13)

where Kₜ is a constant and equals (N_{B}−0.5Nₜ)/Nₜ. Finally, Nₜ is the summation of N_{A} and N_{B}. The same applies to the negative cycle of Vₘ. Based on equations 11-13, pulse multiplication of the supplied current could be achieved using the preferred embodiment of the disclosure. In some cases, it has been shown that the first observed harmonic would be higher than 69th order if the value of constant Kₜ is equal to 0.2457.

### Zero Sequence Blocking Transformer

Considering the output voltage phase differences, the parallel connection of these bridges can cause undesired conduction modes, in some instances. This problem can be overcome, in one embodiment, using an interface. For example, in one embodiment, a ZSBT is used to prevent undesired conduction modes. Considering the 72-pulse output of the converter, the ZSBT imposes high impedance in zero sequence and its multiplication harmonics, and it is an obstacle for their flow. It should be noted that the frequency of the voltage experienced by the ZSBT is five times higher than that of the supply. This means a significant reduction in size and weight of the required ZSBT.

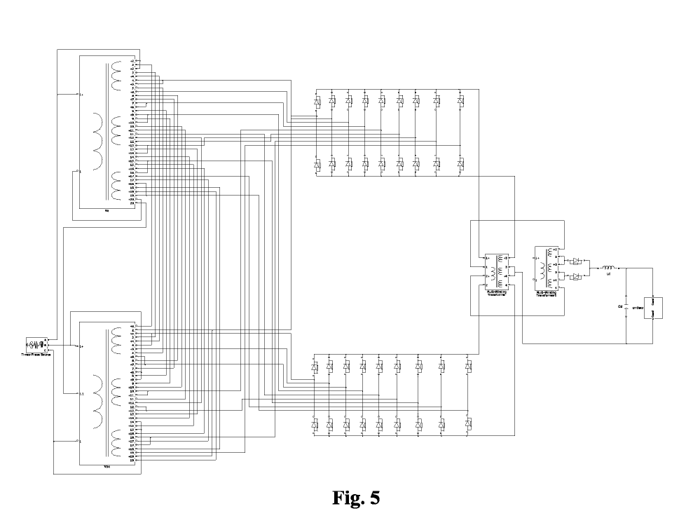

FIG. 5 illustrates a simulated block diagram of the T autotransformer based converter of FIG. 4. In the simulated example, the 72-pulse converter provides a DC link from a three-phase system for an AC induction motor drive. The T-connected autotransformer platform, ZSBT and IPT are modeled using multi-winding transformers. At the converter output (dc link), a series of blocks, consisting of an inductance (L) and a parallel capacitor (C) are connected in the output terminals of the circuit (e.g. DC link), to supply the insulated gate bipolar transistor (IGBT) based voltage source inverter (VSI). In turn, the VSI feeds a squirrel cage induction motor in which direct torque controlled strategy is applied to control the motor speed. Technical specifications of the simulated induction motor are as follows: name plate power: 50 hp (37.3 kW), number of poles: 4-pole, connection type and Y-connected. Three-phase squirrel cage induction motor—50 hp (37.3 kW), three phase, four pole, Y-connected, 460 V, 60 Hz. Rₛ=0.0148 Ω; Rᵣ=0.0092 Ω; Xₗₛ=1.1452; Xₗᵣ=1.14 Ω, X_{Lm}=3.94 Ω, J=3.1 Kg·m².

Controller parameters: PI controller Kp=300; Ki=2000.
DC link parameters: L_{d}=2 mH; C_{d}=3200 μF.
Source impedance: Zₛ=j0.1884 Ω (=3%).

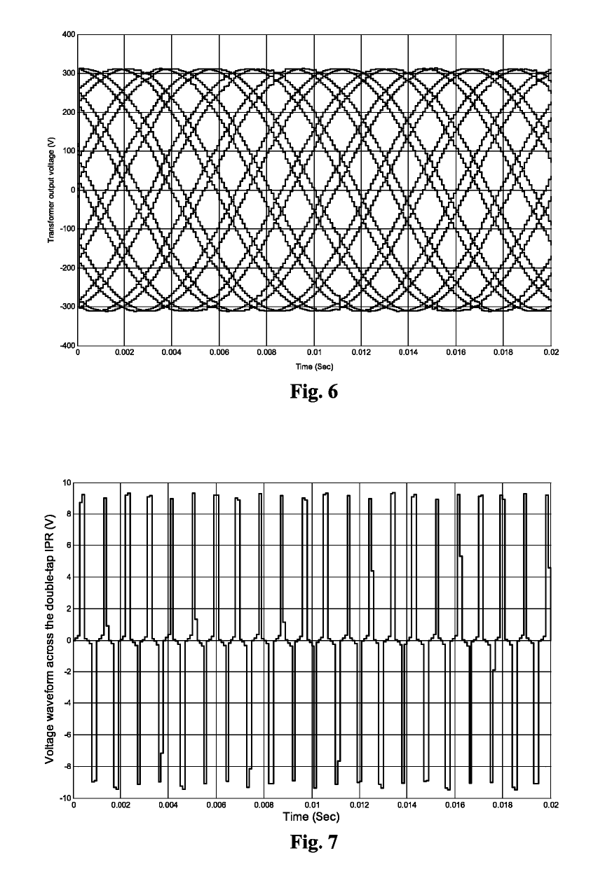

The simulation results are depicted in FIGS. 6-14. FIG. 6 illustrates two groups of nine-phase voltage waveforms with a phase shift of 10 degrees between the same voltages of each group. The voltage across the tapped inter-phase transformer is shown in FIG. 7, which has a frequency 18 times that of the supply frequency. Diode D1 conducts when the voltage across the tapped IPT is positive and, conversely, D2 is on when the voltage across it is in its negative half-cycle.

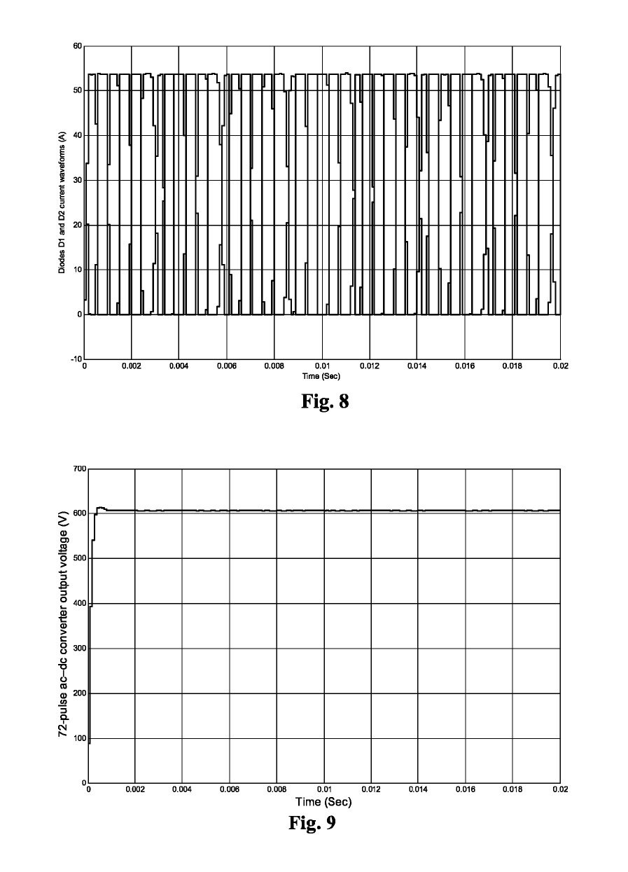

In one embodiment, the conduction sequence of the diodes is an important basis for the pulse doubling technique. The current waveforms of pulse doubling diodes are shown in FIG. 8. The magneto-motive force (MMF) equivalence of the tapped IPT windings is formulated using equation (12). The 72-pulse converter output voltage (shown in FIG. 9) is almost smooth and free of ripples with an average value of 607.2 V, which is approximately equal to the DC link voltage of a six-pulse rectifier (607.6 V). This makes the 72-pulse converter suitable for retrofit applications.

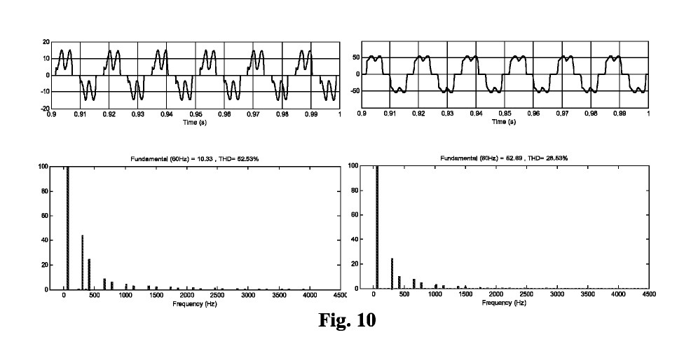

Input current waveforms and the harmonic spectrum of the 6-pulse, 36-pulse, and 72-pulse converters are extracted and shown in FIGS. 10-12, respectively, to check their consistency with the limitations of the IEEE standard 519. These harmonic spectra are obtained when induction motor operates under light load (e.g., 20% of full load) and full load conditions. The input current THD of the typical 6-pulse converter is equal to 28.53% and 52.53% for full load and light load conditions respectively, as illustrated in FIG. 10. As expected, these numbers are relatively large which are not within the standard margins. The presence of low order harmonics is also one of the drawbacks of these types of converters.

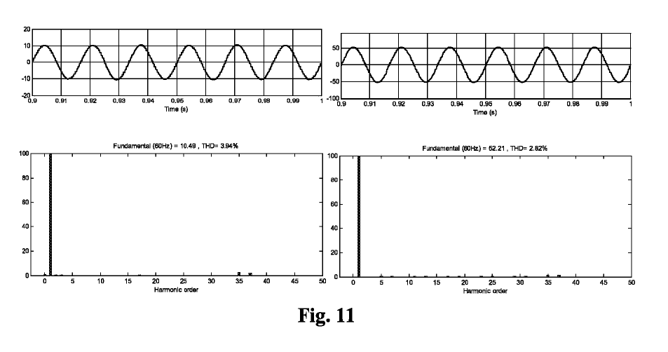

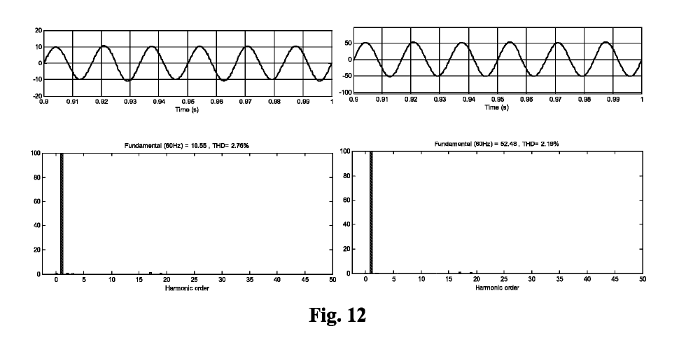

The current THD for the proposed 36-pulse converter is reduced to 2.82% and 3.94% for full load and light load conditions, respectively as shown in FIG. 11. However, the 36-pulde converter could also not meet the requirements of IEEE-519 standard which demonstrates a value of 3% for THD. One achievement for the preferred embodiment of the disclosure is that low order harmonics are diminished in the input current harmonic spectrum. For example, in one embodiment, as a result of applying the pulse multiplication technique up to the 33rd harmonics are eliminated. Moreover, the results of the simulation confirm that the disclosed 72-pulse converter can overcome the high THDs for the input current while applying lower pulse numbers. For example, the simulation shows that the use of the 72-pulse converter results in a current THD of 2.76% for light load and 2.19% for full load conditions as shown in FIG. 12, which is within the requirements of IEEE-519 standard. In this configuration, low order harmonics up to 69th are further eliminated in the supply current. In addition to the supply current THD, other power quality indices such as supply voltage THD, displacement power factor (DPF), distortion factor (DF), and power factor (PF) can also be calculated under different loading conditions. These are illustrated in Table I.

TABLE I
COMPARISON OF SIMULATED POWER QUALITY PARAMETERS
OF THE DTCIMD FED FROM DIFFERENT AC-DC CONVERTERS

| | | | AC Mains | | % THD of I_{SA}, | | Distortion | | Displacement | | Power Factor, | | DC Voltage | |
|---|---|---|---|---|---|---|---|---|---|---|---|---|---|---|
| | | | Current I_{SA} (A) | | at | | Factor, DF | | Factor, DPF | | PF | | (V) | |
| | | % THD | Light | Full | Light | Full | Light | Full | Light | Full | Light | Full | Light | Full |
| Sr. No. | Topology | of V_{ac} | Load | Load | Load | Load | Load | Load | Load | Load | Load | Load | Load | Load |
| 1 | 6-pulse | 5.64 | 10.33 | 52.69 | 52.53 | 28.53 | 0.8850 | 0.9599 | 0.9858 | 0.9881 | 0.8730 | 0.9485 | 616.6 | 607.6 |
| 2 | 36-pulse | 2.46 | 10.49 | 52.21 | 3.94 | 2.82 | 0.9992 | 0.9993 | 0.9996 | 0.9987 | 0.9987 | 0.9980 | 611.5 | 606.8 |
| 3 | 72-pulse | 1.90 | 10.55 | 52.48 | 2.76 | 2.19 | 0.9994 | 0.9996 | 0.9998 | 0.9998 | 0.9993 | 0.9993 | 611.1 | 608.8 |

It can be seen that these indices are significantly improved as higher pulse number converters are utilized. Moreover, the mains power factor for the 72-pulse topology has reached unity from light load to full load conditions.

Different power quality indices of the proposed topology under different loading conditions are shown in Table II. Results show that even under load variations, the 72-pulse converter has an improved performance and the current THD is always less than 3% for all loading conditions. As seen, the power factor is approximately one. Moreover, for the worst case scenario (light loading condition), the current THD remains lower than 3%.

TABLE II
COMPARSION OF POWER QUALITY INDICES
OF PROPOSED 72-PULSE AC-DC CONVERTER

| Load | THD (%) | | CF | | | | RF |
|---|---|---|---|---|---|---|---|
| (%) | I_{S} | V_{S} | of I_{S} | DF | DPF | PF | (%) |
| 20 | 2.76 | 0.78 | 1.4 | 0.9994 | 0.9998 | 0.9993 | 611.1 |
| 40 | 2.43 | 1.30 | 1.4 | 0.9996 | 0.9998 | 0.9993 | 610.5 |
| 60 | 2.35 | 1.52 | 1.4 | 0.9996 | 0.9998 | 0.9993 | 619.9 |
| 80 | 2.30 | 1.63 | 1.4 | 0.9996 | 0.9998 | 0.9993 | 609.3 |
| 100 | 2.19 | 1.90 | 1.4 | 0.9996 | 0.9998 | 0.9993 | 608.8 |

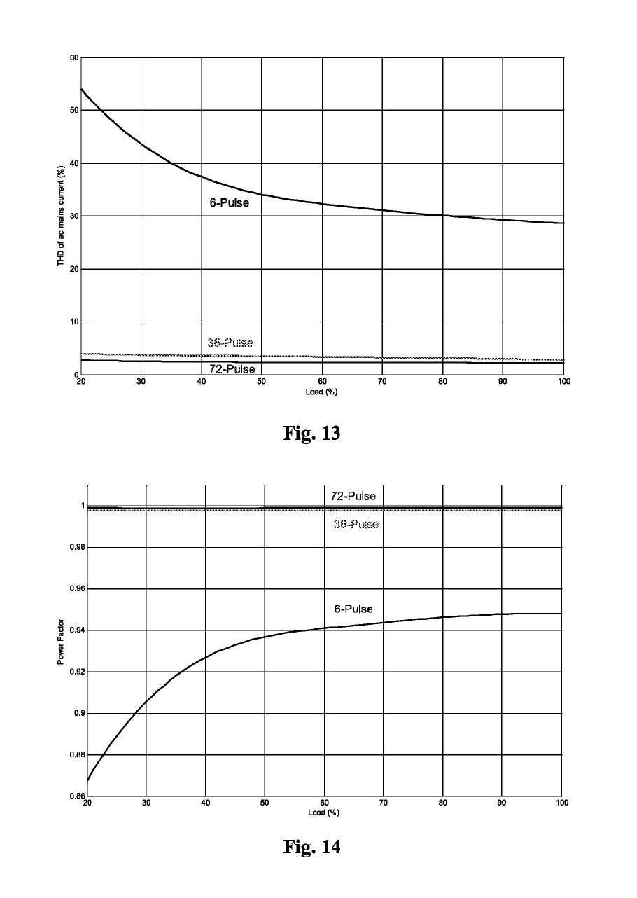

Input current THD and power factor variations are also shown in FIGS. 13 and 14 respectively, for 6-pulse, 36-pulse, and 72-pulse AC-DC converters. Results show that the input current corresponding to the disclosed embodiment has an almost unity power factor. Furthermore, even in worst case scenarios (i.e., light loads), the current THD reaches below 3%.

In this disclosure, an inclusive design of a 72-pulse AC-DC converter has been proposed. The proposed scheme includes a T-connected autotransformer platform that reduces cost. The 72-pulse output has been developed based on a 36-pulse AC-DC converter, using a pulse doubling tapped inter-phase transformer. There are two main advantages for using the proposed converter. The first merit is that the T-connected autotransformer configuration requires two single-phase transformers, which is more economical (in weight and volume) as compared with other topologies using three single-phase transformers. The second one is that the application of the pulse doubling technique with a low power rating (2% of the load power rating) results in a simpler and more economical configuration of the whole system and increased number of pulses. Simulation results confirm that the preferred embodiment of the disclosure meets the requirements of IEEE-519 about input current THD. It is shown that the current THD is less than 3% while supplying a motor from light load condition to full load condition. In addition it is concluded that the power factor of the AC source reaches almost unity and that would reduce the amplitude of current required to drive DTCIMD loads. The preferred embodiment of the disclosed 72-pulse AC-DC converter can be utilized instead of a conventional 6-pulse converter, as it reduces the kilovolt-ampere (kVA) rating and does not imposed more cost for replacing the existing system layout and equipment.

The separation of various components in the examples described above should not be understood as requiring such separation in all examples, and it should be understood that the described components and systems can generally be integrated together in a single packaged into multiple systems.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations for the purpose of streamlining the disclosure. This method of disclosure is not to be interpreted as reflecting an intention that the claimed implementations require more features than are expressly recited in each claim. Rather, as the following claims reflect, inventive subject matter lies in less than all features of a single disclosed implementation. Thus the following claims are hereby incorporated into the Detailed Description, with each claim standing on its own as a separately claimed subject matter.

What is claimed is:

1. A T-connected autotransformer based 72-pulse AC-DC converter comprising:
a T-connected autotransformer based 36-pulse AC-DC configuration comprising a T-connected autotransformer and first and second 18-pulse AC-DC converters,
wherein the first and the second 18-pulse AC-DC converters are parallel, and wherein each one of the first and second 18-pulse AC-DC converters comprises a nine-phase diode bridge rectifier.

2. The 72-pulse AC-DC converter of claim 1, further comprising a pulse doubling circuit for doubling a number of pulses from 36 to 72.

3. The 72-pulse AC-DC converter of claim 1, wherein the pulse doubling circuit is comprised of a tapped inter-phase transformer.

4. The 72-pulse AC-DC converter of claim 1, wherein a zero sequence blocking transformer (ZBST) operates each nine-phase bridge diode rectifier.

5. The 72-pulse AC-DC converter of claim 4, wherein a tapped inter phase transformer is located at an output of the ZBST, and the tapped inter phase inter phase transformer doubles voltage pulses of the output of ZBST to 72.

6. The 72-pulse AC-DC converter of claim 5, wherein the output of ZBST is smooth and ripple free.

7. The 72-pulse AC-DC converter of claim 5, wherein the output of ZBST has an average voltage value of 608.8 V, which is approximately equal to a DC link voltage of a six-pulse rectifier.

8. The 72-pulse AC-DC converter of claim 5, wherein a voltage frequency of the ZBST is nine times higher than of a supply frequency.

9. The 72-pulse AC-DC converter of claim 6, wherein the ZBST comprises high impedance at zero sequence and multiple harmonics currents.

10. The 72-pulse AC-DC converter of claim 1, wherein the T-connected autotransformer is supplies each nine-phase diode bridge rectifier.

11. The 72-pulse AC-DC converter of claim 1, wherein The T-connected autotransformer comprises first and second single-phase transformers.

12. The 72-pulse AC-DC converter of claim 1, wherein average voltage output of the nine-phase diode bridge rectifiers are equal and phase shifted by 10 degrees.

13. The 72-pulse AC-DC converter of claim 1, wherein an input current total harmonic distortion (THD) is less that 3% in most loading conditions.

14. The 72-pulse AC-DC converter of claim 1, further comprising an AC source, wherein a power factor of the AC source is close to or equal to unity.

15. The 72-pulse AC-DC converter of claim 14, wherein the power factor reduces an amplitude of current required to drive one or more DTCIMD loads.
